(19) United States
(12) Patent Application Publication
(10) Pub. No.: US 2024/0023565 A1
(43) Pub. Date: Jan. 25, 2024

(54) FROZEN SHUMAI

(71) Applicant: AJINOMOTO CO., INC., Tokyo (JP)

(72) Inventor: Yuki SHIMIZU, Kawasaki-shi (JP)

(73) Assignee: AJINOMOTO CO., INC., Tokyo (JP)

(21) Appl. No.: 18/354,279

(22) Filed: Jul. 18, 2023

(30) Foreign Application Priority Data
Jul. 19, 2022 (JP) 2022-115045

(51) Int. Cl. A21D 13/31; A23L 5/10

(52) U.S. Cl. CPC A21D 13/31; A23L 5/15

(57) ABSTRACT

A frozen shumai in which hardening of a part of a shumai wrapper which is not in contact with a shumai filling is suppressed, and deterioration of texture during eating is improved even when the frozen shumai taken out from a freezer is heated as it is in a microwave oven without a treatment or operation of spraying water on the surface of the frozen shumai or covering the frozen shumai with a food wrap film is provided. Specifically, a frozen shumai containing a shumai wrapper and a shumai filling, wherein a water content of a part of the shumai wrapper which is not in contact with the shumai filling is 35 wt % to 80 wt % after heating the shumai as it is in a microwave oven until a core temperature of the shumai reaches 50° C. to 90° C. is provided.

### TECHNICAL FIELD OF THE INVENTION

The present invention relates to frozen shumai suitable for heating in a microwave oven.

### BACKGROUND OF THE INVENTION

Shumai (Siumai, Chinese steamed dumpling) is one of the representative dim sum along with gyoza and baozi (Chinese meat bun), and is widely used at home. Frozen shumai is made by wrapping the filling with a wrapper, shaping the resulting shumai, heating, and then freezing the shumai. With the advancement of food manufacturing technology and food freezing technology, frozen shumai is widely supported by consumers as a food that can be stored for a long time and can soon be ready for eating by heating at the time of eating. Single-person households and double-income households have increased in recent years, and there is a growing demand for convenience and speed in cooking. Microwave ovens are often used to cook frozen shumai.

When heating frozen shumai in a microwave oven, it is recommended to spray water on the surface of the frozen shumai or cover the frozen shumai with a food wrap film before heating in order to prevent uneven heating and to heat uniformly. When heated in a microwave oven without such treatment or operation, problems occur in that the wrapper at the top and/or the sides of the shumai, which is not in contact with the filling, becomes hard and the texture during eating is deteriorated.

There are various reports on the problems in cooking frozen dim sum that the heating state becomes uneven, partial drying or hardening occurs, and the texture at the time of eating deteriorates, and many efforts have been made to solve these problems.

There have been proposed a technique for providing a grain flour processed food having a large number of starch particles with a major diameter of 20 μm to 50 μm and a gap with a thickness of 0.5 μm to 2.5 μm around the starch particles, which enables formation of a highly uniform dispersion structure of water molecules in food tissue, thereby suppressing partial drying or hardening caused by, particularly during microwave heating, concentration of microwaves due to non-uniform moisture in the food tissue (JP-A-11-262364, which is incorporated herein by reference in its entirety), and a technique for providing seal-packaged frozen dim sum, in which the wrapper constituting the dim sum contains at least a grain powder and saccharides and has a water content of not less than 33 wt % and not more than 38.5 wt % at the stage of opening the package and taking out the dim sum, and which does not lose its texture even when cooked in a frying pan without a lid (WO 2020/036226, which is incorporated herein by reference in its entirety).

However, even though JP-A-11-262364 discloses that it is important to eliminate uneven distribution of water molecules in the food tissue in order to improve deterioration of texture particularly due to heating in a microwave oven, no attention has been paid to the water content of the wrapper that constitutes the wrapped foods. In addition, the effect of improving the texture deteriorated by heating in a microwave oven has been demonstrated only in gyoza dumplings. It is unclear whether the same effect as in gyoza dumplings with a structure in which edges of the wrapper stick together is also observed in shumai, which has a shape including many corners by folding the wrapper in irregular shapes.

In addition, since the frozen dim sum described in WO 2020/036226 is cooked in a frying pan, the wrapper is steamed with moisture from the wing forming agent (batter) in the dim sum and softened compared to heating in a microwave oven. Accordingly, the technique disclosed in WO 2020/036226 cannot be directly applied to frozen shumai to be heated in a microwave oven.

Therefore, there is a demand for frozen shumai, which shows suppressed hardening of the wrapper when heated in a microwave oven even without a treatment or operation of spraying water on the surface of the frozen shumai or covering the frozen shumai with a food wrap film, and improved deterioration of texture when eaten.

### SUMMARY OF THE INVENTION

Therefore, the present invention aims to provide frozen shumai in which hardening of a part of a shumai wrapper which is not in contact with a shumai filling is suppressed, and deterioration of texture during eating is improved even when the frozen shumai is heated as it is in a microwave oven without a treatment or operation of spraying water on the surface of the frozen shumai or covering the frozen shumai with a food wrap film.

The present inventor has conducted intensive studies in an attempt to solve the aforementioned problems and found that hardening of a part of a shumai wrapper which is not in contact with a shumai filling is suppressed after heating the shumai in a microwave oven is suppressed, and deterioration of texture during eating is improved, by setting a water content of the part of the shumai wrapper which is not in contact with the shumai filling to 35 wt % to 80 wt % after heating the shumai as it is in a microwave oven until a core temperature of the shumai reaches 50° C. to 90° C. Further studies have resulted in the completion of the present invention.

That is, the present invention relates to the following.

[1] A frozen shumai comprising a shumai wrapper and a shumai filling, wherein a water content of a part of the shumai wrapper which is not in contact with the shumai filling is 35 wt % to 80 wt % after heating the shumai as it is in a microwave oven until a core temperature of the shumai reaches 50° C. to 90° C.

[2] The frozen shumai of [1], wherein the water content of the part of the shumai wrapper which is not in contact with the shumai filling is 37 wt % to 70 wt % before heating in the microwave oven, and a ratio of the water content of the part of the shumai wrapper which is not in contact with the shumai filling after heating the shumai as it is in the microwave oven until the core temperature of the shumai reaches 50° C. to 90° C. to the water content before heating of the part of the shumai wrapper which is not in contact with the shumai filling ([water content of the part of the shumai wrapper which is not in contact with the shumai filling after heating the shumai as it is in the microwave oven until the core temperature of the shumai reaches 50° C. to 90° C.]/[water content before heating of the part of the shumai wrapper which is not in contact with the shumai filling]×100) is 82% to 105%.

[3] The frozen shumai of [1] or [2], which is suitable for heating as it is in a microwave oven without spraying water on a surface of the frozen shumai or covering the frozen shumai with a food wrap film.

[4] A method for improving deterioration of texture of a frozen shumai comprising a shumai wrapper and a shumai filling, due to heating the frozen shumai as it is in a microwave oven, comprising achieving a water content of 35 wt % to 80 wt % of a part of the shumai wrapper which is not in contact with the shumai filling after heating the shumai as it is in a microwave oven until a core temperature of the shumai reaches 50° C. to 90° C.

[5] The method of [4], wherein the water content of the part of the shumai wrapper which is not in contact with the shumai filling is set to 37 wt % to 70 wt % before heating in the microwave oven, and a ratio of the water content of the part of the shumai wrapper which is not in contact with the shumai filling after heating the shumai as it is in the microwave oven until the core temperature of the shumai reaches 50° C. to 90° C. to the water content before heating of the part of the shumai wrapper which is not in contact with the shumai filling ([water content of the part of the shumai wrapper which is not in contact with the shumai filling after heating the shumai as it is in the microwave oven until the core temperature of the shumai reaches 50° C. to 90° C.]/[water content before heating of the part of the shumai wrapper which is not in contact with the shumai filling]×100) is set to 82% to 105%.

[6] The method of [4] or [5], wherein the heating in the microwave oven is performed without spraying water on a surface of the frozen shumai or without covering the frozen shumai with a food wrap film.

According to the present invention, frozen shumai suitable for heating in a microwave oven can be provided, in which hardening of a part of a shumai wrapper in a top part and/or a side part of the shumai not in contact with a shumai filling is suppressed, and deterioration of texture during eating is improved even when the frozen shumai is heated in a microwave oven without a treatment or operation of spraying water on the surface of the frozen shumai or covering the frozen shumai with a food wrap film.

### DETAILED DESCRIPTION OF THE INVENTION

The present invention is described below. Unless otherwise specified, the terms used in the present specification have meanings generally used in the pertinent field.

The present invention provides frozen shumai suitable for heating in a microwave oven (hereinafter also to be referred to as “the frozen shumai of the present invention” in the present specification).

The frozen shumai of the present invention is characterized in that a water content of a part of a shumai wrapper which is not in contact with a shumai filling is 35 wt % to 80 wt %, after heating the shumai as it is in a microwave oven until a core temperature of the shumai reaches 50° C. to 90° C. (hereinafter said water content after said heating is to be indicated using a symbol “WA”).

In the present invention, the “frozen shumai” is not particularly limited as long as shumai, which is generally produced as one type of Chinese dim sum, is frozen by a freezing method generally employed in the field of food, as described below.

In the present specification, “heating as it is in a microwave oven” refers to heating a frozen shumai taken out of a freezer in a microwave oven without a treatment or operation of spraying water on the surface thereof or covering the frozen shumai with a food wrap film.

The conditions for heating in a microwave oven are not particularly limited as long as they are generally used for cooking frozen foods, and can heat shumai to a core temperature of 50° C. to 90° C. For example, 3 or 4 pieces of frozen shumai are cooked at 500 W to 1400 W for about 30 seconds to 6 minutes.

Furthermore, in the present specification, “a water content of a part of the shumai wrapper which is not in contact with the shumai filling” refers to a water content of a shumai wrapper in a part of a top part and/or a side part of the shumai not in contact with the shumai filling.

In the frozen shumai of the present invention, WA is 35 wt % to 80 wt %.

WA is preferably not less than 38 wt %, more preferably not less than 39 wt %. WA is preferably not more than 70 wt %, more preferably not more than 65 wt %, further preferably not more than 60 wt %, further more preferably not more than 55 wt %.

Furthermore, in the frozen shumai of the present invention, a water content of a part of a shumai wrapper which is not in contact with a shumai filling, before heating in a microwave oven (hereinafter said water content before said heating is to be indicated using a symbol “WB”) is preferably 37 wt % to 70 wt %, and a ratio of WA to WB ([WA]/[WB]×100) is preferably 82% to 105%. In addition, more preferably, WB is 39 wt % to 60 wt %, and a ratio of WA to WB ([WA]/[WB]×100) is 82% to 103%. Further preferably, WB is 39 wt % to 57 wt %, and a ratio of WA to WB ([WA]/[WB]×100) is 82% to 103%.

The water content of the part of the shumai wrapper which is not in contact with the shumai filling can be determined by a loss on drying method as described below.

In the present invention, shumai is produced by wrapping a filling, which is prepared by chopping and grinding ingredients and mixing them according to a general composition and method, in a shumai wrapper prepared primarily from a grain powder such as wheat flour and the like, followed by molding into a cylindrical shape or the like and steaming.

The ingredients contained in the filling of shumai are not particularly limited, and livestock meat such as pork and chicken; fish and shellfish such as shrimp, crab, squid, white-meat fish, asari clam, and escallop; vegetables such as Chinese cabbage, cabbage, onion, bamboo shoot, green onion, and ginger; mushrooms such as shiitake mushroom; and the like may be contained.

In addition, when preparing the filling, general food additives including seasonings such as salt, sugar, soy sauce, amino acid salt, nucleic acid salt, yeast extract, and meat extract; starch and processed starch; animal-derived proteins such as egg white, gelatin, and casein; hydrolysates and partial hydrolysates of the aforementioned animal-derived proteins; pH adjusters such as organic acid salts (e.g., fumarate); chelating agents such as polyphosphoric acid salt; coloring matter, acidulant, flavor, and the like can also be added.

Shumai wrapper can be prepared by mixing wheat flour (soft wheat-flour and hard wheat flour) and water (lukewarm water) to form a dough, spreading same thinly and cut it appropriately. When preparing shumai wrapper, salts such as sodium chloride; wheat protein; spiritus; fat and oil such as plant-derived fat and oil; starch, processed starch (starch acetate, monostarch phosphate, distarch phosphate, hydroxypropylstarch, hydroxypropyl distarch phosphate, etc.), carbohydrates such as xylose, trehalose, and reduced starch syrup, and the like can be added.

In addition to the amount of water added in the preparation of shumai wrapper, additives that have the property of retaining moisture from among the food additives to be added to shumai wrapper, for example, fat and oil, starch, processed starch, carbohydrates such as xylose, trehalose, and reduced starch syrup may affect WA and the ratio of WA to WB. Therefore, the amount of water and the amount of the above-mentioned additives that have the property of retaining moisture to be added in the preparation of shumai wrapper can regulate WA and the ratio of WA to WB.

Also, the salts and wheat protein added to shumai wrapper may affect the texture (hardness) of the shumai wrapper because hardening of shumai wrapper is accelerated by the formation of gluten.

As the size and thickness of the shumai wrapper, size and thickness suitable for wrapping the filling when preparing shumai can be adopted.

Shumai wrapper is prepared to fulfill the above-mentioned WA and the above-mentioned ratio of WA to WB and used, and a commercially available shumai wrapper that fulfills such water content and water content ratio can also be used.

As the shape and size of shumai, generally employed shapes (e.g., cylindrical, spherical, ellipse spherical, etc.) and sizes (e.g., diameter and height of about 2 cm to about 5 cm, each) can be employed.

The ratio of the weight of shumai wrapper to the total weight of shumai has little effect; however, the shape of shumai wrapper in the top part and/or the side part of shumai, the method of wrapping the filling, and the like may affect WA and the ratio of WA to WB.

The shaped shumai can be steamed using a steamer, a steam convection oven, or the like, and the conditions at that time can be the those generally adopted for heating shumai. The conditions for steaming may affect WB. Steamed shumai is cooled and then frozen.

As the means for cooling, cooling means generally employed in the production of foods, for example, allowing to cool at room temperature, blast cooling, cooling with running water, and the like can be used.

As a means of freezing, general freezing means employed in the production of foods, for example, freezing at about −18° C. to −40° C. in a freezer, quick freezing, and the like can be employed. From the viewpoint of maintaining the quality of shumai during the storage period, quick freezing is preferred.

Quick freezing can be performed using a quick freezer generally used in the field of foods, such as an air blast freezer, a liquefied gas freezer, and a contact freezer.

In the frozen shumai of the present invention, hardening of a part of a shumai wrapper in a top part and/or a side part of the shumai not in contact with a filling is suppressed, and deterioration of texture during eating is improved even when the frozen shumai is taken out of the freezer and heated as it is in a microwave oven without a treatment or operation of spraying water on the surface of the frozen shumai or covering the frozen shumai with a food wrap film.

In the frozen shumai of the present invention, in which WA, WB, and the ratio of WA to WB are controlled as described above, cracking of the shumai wrapper due to transportation can be reduced even when the shumai is directly wrapped in a packaging material without being placed in a tray.

In addition, the present invention provides a method for improving deterioration of texture of a shumai when the frozen shumai is heated as it is in a microwave oven (hereinafter sometimes to be referred to as “the improving method of the present invention” in the present specification).

The improving method of the present invention includes setting WA to 35 wt % to 80 wt %.

In the improving method of the present invention, “frozen shumai”, “shumai wrapper”, “heating as it is”, and “a water content of a part of the shumai wrapper which is not in contact with the shumai filling”, as well as the conditions of heating in a microwave oven are as described above for the frozen shumai of the present invention.

In the improving method of the present invention, WA is preferably set to not less than 38 wt %, more preferably not less than 39 wt %. In addition, WA is preferably set to not more than 70 wt %, more preferably not more than 65 wt %, further preferably not more than 60 wt %, and further more preferably not more than 55 wt %.

In the improving method of the present invention, moreover, WB is preferably set to 37 wt % to 70 wt %, and the ratio of WA to WB ([WA]/[WB]×100) is preferably set to 82% to 105%. It is more preferable to set WB to 39 wt % to 60 wt %, and the ratio of WA to WB ([WA]/[WB]×100) to 82% to 103%. It is further preferable to set WB to 39 wt % to 57 wt %, and the ratio of WA to WB ([WA]/[WB]×100) to 82% to 103%.

The measurement method of the water content of the part of the shumai wrapper which is not in contact with the shumai filling is as described above for the frozen shumai of the present invention.

In the improving method of the present invention, WA and the ratio of WA to WB may be affected by, as described above for the frozen shumai of the present invention, the amount of water added when preparing the shumai wrapper, the amount of additives that have the property of retaining moisture, the shape of the shumai wrapper on the top part and/or the side part of the shumai, a method of wrapping the filling, steaming conditions, and the like.

Therefore, in the improving method of the present invention, WA and the ratio of WA to WB may be regulated to fall within the above-mentioned ranges by appropriately adjusting the amount of water added when preparing the shumai wrapper, the amount of additives that have the property of retaining moisture (fat and oil, starch, processed starch, carbohydrates such as xylose, trehalose, reduced starch syrup, and the like), the shape of the shumai wrapper on the top part and/or the side part of the shumai, a method of wrapping the filling, steaming conditions, and the like.

As described above for the frozen shumai of the present invention, moreover, the texture of shumai wrapper to be improved by the improving method of the present invention may be affected by the acceleration of hardening via formation of gluten by salts and wheat proteins contained in the shumai wrapper.

According to the improving method of the present invention, hardening of a part of a shumai wrapper in a top part and/or a side part of the shumai not in contact with a filling is suppressed, and deterioration of texture of shumai during eating, which is caused by partial hardening of the shumai wrapper, is improved even when the frozen shumai is taken out of the freezer and heated as it is in a microwave oven without a treatment or operation of spraying water on the surface of the frozen shumai or covering the frozen shumai with a food wrap film.

### EXAMPLE

The present invention is described in detail below using examples, but the present invention is not limited in any way. Reagents and materials to be used are commercially available unless otherwise specified, or can be prepared from known literature and the like. In addition, those skilled in the art understand that other substances having similar effects and actions can be used alternatively.

### [Examples 1-9, Comparative Examples 1-4] Frozen Shumai

The weight and size (diameter×height) per one piece of shumai, wrapper thickness, type of filling, and the ratio of wrapper weight to the total weight, of the frozen shumai of Examples 1 to 9 and Comparative Examples 1 to 4 are shown in Table 1. Each shumai of these Examples and Comparative Examples was produced by wrapping each of the types of fillings shown in Table 1 in a shumai wrapper, and the shaping same into a cylindrical shape, followed by steaming, then freezing, and storing at −18° C.

The ratio of the wrapper weight to the total weight of shumai was determined by covering each shumai of the above-mentioned Examples and Comparative Examples with a food wrap film, leaving same for about 30 min at ordinary temperature to allow for partial thawing, peeling off shumai wrapper from the filling with tweezers in shumai in the number (3 to 8) that renders the total weight 150 g or more, and measuring the weight of the shumai wrapper.

Each frozen shumai of the Examples and Comparative Examples was subjected to measurement of WB, heating in a microwave oven, measurement of WA, and evaluation of texture of shumai (hardness of shumai wrapper) after heating in the microwave oven.

### (1) Measurement of WB

Each frozen shumai of the above-mentioned Examples and Comparative Examples was taken out from a freezer, the shumai wrapper of the part not in contact with the filling (reference weight=1.0 wt % to 4.5 wt % of the total weight of shumai) was immediately cut out with scissors so as not to be thawed, the weight thereof was immediately measured so as not to be thawed, and the wrapper was dried in a dryer at 105° C. for 6 hr. The weight after drying was measured, and WB was calculated from the difference in the weight before and after drying.

### (2) Heating of Frozen Shumai in Microwave Oven

Each frozen shumai of the above-mentioned Examples and Comparative Examples was taken out from a freezer, 3 or 4 thereof were placed on a dish, and heated in a microwave oven (“NE-1901”, Panasonic Corporation) at 1400 W until the core temperature of the shumai reached 50° C. to 90° C. (about 80° C. in about 80%) without applying a food wrap film. The core temperature was measured at 2 sites for each shumai.

### (3) Measurement of WA

After heating in the microwave oven as described above, each shumai was allowed to cool for about 10 min, a part of the shumai wrapper which is not in contact with the shumai filling (reference weight=1.0 wt % to 4.5 wt % of the total weight of shumai) was cut out with scissors, the weight of the wrapper was immediately measured so as not to be dried, and the wrapper was dried in a dryer at 105° C. for 6 hr. The weight after drying was measured, and WA was calculated from the difference in the weight before and after drying.

(4) Evaluation of Texture of Shumai (Hardness of Shumai Wrapper) after Heating in Microwave Oven

Each frozen shumai of the Examples and Comparative Examples was heated in a microwave oven as described in the above-mentioned (2) and allowed to cool. A sensory evaluation of the texture of the shumai (hardness of shumai wrapper) was performed by 5 panelists. The hardness of the shumai wrapper when the shumai was eaten was evaluated by the panelists according to the following evaluation criteria, and the evaluation score was determined as the evaluation results through discussions among the 5 panelists. When the evaluation score was 3 points or 2 points, the texture of the shumai wrapper at the time of eating was determined to be good.

### <Evaluation Criteria>

3 points; soft
2 points; slightly hard
1 point; hard and crunchy

### (5) Results

The above-mentioned measurement results and evaluation results are shown together in Table 1.

TABLE 1

| | | size (dia- | thickness | | weight ratio | core | | | | hardness |
|---|---|---|---|---|---|---|---|---|---|---|
| | | meter × | (mm) of | | (wt %) of shumai | temperature | | | | (point) of |
| | weight | height) | shumai | type of | wrapper to the | (° C.) after | WB | WA | WA/WB | shumai |
| sample | (g/shumai) | (cm) | wrapper | filling | total weight | heating | (wt %) | (wt %) | (%) | wrapper |
| Example 1 | 28 | 3.5 × 3.5 | 0.45 | meat | 25 | 72-86 | 56.56 | 50.81 | 89.82 | 3 |
| Example 2 | 30 | 4.0 × 3.0 | 0.90 | meat | 24 | 64-88 | 51.92 | 42.86 | 82.54 | 3 |
| Example 3 | 40 | 4.3 × 3.5 | 0.80 | meat | 19 | 76-89 | 53.44 | 49.94 | 93.45 | 3 |
| Example 4 | 50 | 4.5 × 4.0 | 1.00 | meat | 16 | 51-66 | 46.93 | 46.20 | 98.45 | 3 |
| Example 5 | 45 | 4.2 × 4.0 | 0.60 | meat | 19 | 76-90 | 51.90 | 53.33 | 102.75 | 3 |
| Example 6 | 24 | 3.5 × 3.0 | 0.60 | meat | 24 | 70-82 | 48.95 | 45.52 | 92.99 | 2 |
| Example 7 | 35 | 4.0 × 3.5 | 0.45 | meat | 18 | 50-82 | 39.27 | 39.38 | 100.30 | 2 |
| Example 8 | 45 | 4.7 × 3.5 | 0.50 | meat | 24 | 60-85 | 51.87 | 44.64 | 86.06 | 2 |
| Example 9 | 40 | 4.5 × 3.5 | 0.95 | meat | 21 | 50-82 | 39.71 | 35.79 | 90.12 | 2 |
| Comparative | 28 | 3.5 × 3.5 | 0.90 | meat | 19 | 85-90 | 35.18 | 32.15 | 91.39 | 1 |
| Example 1 | | | | | | | | | | |
| Comparative | 32 | 3.7 × 3.2 | 0.83 | fish | 20 | 60-76 | 39.89 | 31.12 | 78.01 | 1 |
| Example 2 | | | | meat | | | | | | |
| | | | | paste | | | | | | |
| Comparative | 26 | 3.8 × 2.8 | 0.55 | meat | 18 | 86-90 | 43.01 | 34.82 | 80.95 | 1 |
| Example 3 | | | | | | | | | | |
| Comparative | 35 | 4.0 × 3.2 | 0.85 | meat | 23 | 78-85 | 48.08 | 33.67 | 70.03 | 1 |
| Example 4 | | | | | | | | | | |

As shown in Table 1, in the frozen shumai of Examples 1 to 9, WA was 35.79 wt % to 53.33 wt %. In addition, WB was 39.27 wt % to 56.56 wt %, and the ratio of WA to WB ([WA]/[WB]×100) was 82.54% to 102.75%. For such frozen shumai of Examples 1-9, the hardness of the shumai wrapper after heating in a microwave oven was evaluated as soft or slightly hard, and the texture of the shumai wrapper was determined to be good when eaten.

In contrast, in the frozen shumai of Comparative Example 1, WB was 35.18 wt %, WA was 32.15 wt % which is less than 35 wt %. In the frozen shumai of Comparative Examples 2 to 4, WB was each not less than 37 wt %, the ratio of WA to WB ([WA]/[WB]×100) was 70.03% to 80.95%, all of which are less than 82%, and WA was less than 35 wt % for all. In the frozen shumai of Comparative Examples 1 to 4, the hardness of shumai wrapper after heating in a microwave oven was evaluated to be each “hard and crunchy”, and the texture of shumai wrapper at the time of eating was found to have deteriorated.

From the above-mentioned results, it is suggested that when WA is not less than 35 wt %, hardening of a part of the shumai wrapper which is not in contact with the shumai filling due to microwave heating is suppressed, and deterioration of texture of shumai during eating is improved.

From the aspects of the effect of suppressing the hardening of a part of the shumai wrapper which is not in contact with the shumai filling due to microwave heating, and the effect of improving deterioration of texture of shumai during eating, it was suggested that WB is more preferably 39 wt % to 57 wt %, and the ratio of WA to WB ([WA]/[WB]×100) is more preferably 82% to 103%.

The results shown in Table 1 suggest that the influence of the size of frozen shumai, thickness of shumai wrapper, and ratio of the weight of shumai wrapper to the total weight of shumai on the texture of shumai (hardness of shumai wrapper) after heating in the microwave oven is small.

### INDUSTRIAL APPLICABILITY

As described in detail above, according to the present invention, frozen shumai suitable for heating in a microwave oven can be provided, in which hardening of a part of a shumai wrapper in a top part and/or a side part of the shumai not in contact with a shumai filling is suppressed, and deterioration of texture during eating is improved even when the frozen shumai taken out from a freezer is heated as it is in a microwave oven without a treatment or operation of spraying water on the surface of the frozen shumai or covering the frozen shumai with a food wrap film.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

This application is based on patent application No. 2022-115045, filed on Jul. 19, 2022 in Japan, and the contents disclosed therein are hereby entirely incorporated by reference.

All patents and other references mentioned above are incorporated in full herein by this reference, the same as if set forth at length.

What is claimed is:

1. A frozen shumai comprising a shumai wrapper and a shumai filling, wherein a water content of a part of the shumai wrapper which is not in contact with the shumai filling is 35 wt % to 80 wt % after heating the shumai as it is in a microwave oven until a core temperature of the shumai reaches 50° C. to 90° C.

2. The frozen shumai according to claim 1, wherein the water content of the part of the shumai wrapper which is not in contact with the shumai filling is 37 wt % to 70 wt % before heating in the microwave oven, and a ratio of the water content of the part of the shumai wrapper which is not in contact with the shumai filling after heating the shumai as it is in the microwave oven until the core temperature of the shumai reaches 50° C. to 90° C. to the water content before heating of the part of the shumai wrapper which is not in contact with the shumai filling ([water content of the part of the shumai wrapper which is not in contact with the shumai filling after heating the shumai as it is in the microwave oven until the core temperature of the shumai reaches 50° C. to 90° C.]/[water content before heating of the part of the shumai wrapper which is not in contact with the shumai filling]×100) is 82% to 105%.

3. The frozen shumai according to claim 1, which is suitable for heating as it is in a microwave oven without spraying water on a surface of the frozen shumai or covering the frozen shumai with a food wrap film.

4. The frozen shumai according to claim 2, which is suitable for heating as it is in a microwave oven without spraying water on a surface of the frozen shumai or covering the frozen shumai with a food wrap film.

5. A method for improving deterioration of texture of a frozen shumai comprising a shumai wrapper and a shumai filling, due to heating the frozen shumai as it is in a microwave oven, comprising achieving a water content of 35 wt % to 80 wt % of a part of the shumai wrapper which is not in contact with the shumai filling after heating the shumai as it is in a microwave oven until a core temperature of the shumai reaches 50° C. to 90° C.

6. The method according to claim 5, wherein the water content of the part of the shumai wrapper which is not in contact with the shumai filling is set to 37 wt % to 70 wt % before heating in the microwave oven, and a ratio of the water content of the part of the shumai wrapper which is not in contact with the shumai filling after heating the shumai as it is in the microwave oven until the core temperature of the shumai reaches 50° C. to 90° C. to the water content before heating of the part of the shumai wrapper which is not in contact with the shumai filling ([water content of the part of the shumai wrapper which is not in contact with the shumai filling after heating the shumai as it is in the microwave oven until the core temperature of the shumai reaches 50° C. to 90° C.]/[water content before heating of the part of the shumai wrapper which is not in contact with the shumai filling]×100) is set to 82% to 105%.

7. The method according to claim 5, wherein the heating in the microwave oven is performed without spraying water on a surface of the frozen shumai or without covering the frozen shumai with a food wrap film.

8. The method according to claim 6, wherein the heating in the microwave oven is performed without spraying water on a surface of the frozen shumai or covering the frozen shumai with a food wrap film.
